(19) United States
(12) Patent Application Publication
(10) Pub. No.: US 2026/0268806 A1
(43) Pub. Date: Sep. 10, 2026

(54) Multi-piece artificial animal appendage

(71) Applicant: Troy Rose, Kooskia, ID (US)

(72) Inventor: Troy Rose, Kooskia, ID (US)

(21) Appl. No.: 19/071,702

(22) Filed: Mar. 5, 2025

(51) Int. Cl. G09B 23/36; B29C 37/00; B29L 31/00

(52) U.S. Cl. CPC G09B 23/36; B29C 37/0053; B29L 2031/7028

(57) ABSTRACT

A multi-piece simulated animal appendage for use in taxidermy. The pieces are detachable for painting and matching and attachable for final display. Pieces are interchangeable to achieve a desired appearance. A combination of flexible and rigid pieces may be combined as desired.

### CROSS-REFERENCE TO RELATED APPLICATIONS

This application claims priority to pending provisional application 63/561,520 filed on Mar. 5, 2024.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

In taxidermy, customers often desire a highly realistic and life-like presentation of a subject. Certain portions of an animal may be difficult to preserve there may be another reason to substitute a replica. Therefore, certain parts of an animal may be replaced with simulated substitutes. These simulated substitutes may be as small as an eye or tooth, or as extensive as an entire head or leg. Pre-painted simulated animal parts reduce the amount of work required by a taxidermist, generally at the expense of increased cost when compared to other options.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

A multi-piece simulated animal appendage for use in taxidermy.

### BRIEF DESCRIPTION OF THE SEVERAL VIEWS OF THE DRAWING

FIG. 1 shows a multi-piece artificial bird head of the present invention. The head is a receiving member. The eye and bill are attaching members. The bill is rigid and attaches to the head by a protrusion on the beak and an aperture in the head.

FIG. 2 shows a top view of a multi-piece artificial bird head of the present invention. The head is a receiving member. The bill is an attaching member. The bill is rigid and attaches to the head by a protrusion on the bill and an aperture in the head.

FIG. 3 shows a side view of a multi-piece artificial bird head of the present invention. The head is a receiving member. The bill is an attaching member. The bill is rigid and attaches to the head by a protrusion on the bill and an aperture in the head.

FIG. 4 shows a side view of a multi-piece artificial bird head of the present invention. The head is a receiving member. The bill is an attaching member. The bill is rigid and attaches to the head by a protrusion on the bill and an aperture in the head. The protrusion is partially inserted into the aperture.

FIG. 5 shows a multi-piece artificial bird head of the present invention. The head is a receiving member and the bill is an attaching member. The bill is comprised of a flexible elastomer and slides over a portion of the head. The bill comprises an aperture and is installed on a protrusion of the head.

FIG. 6 shows a top view of a multi-piece artificial bird head of the present invention. The head is a receiving member and the bill is an attaching member. The bill is comprised of a flexible elastomer and slides over a portion of the head. The bill comprises an aperture and is attachable on a protrusion of the head.

FIG. 7 shows a side view of a multi-piece artificial bird head of the present invention. The head is a receiving member and the bill is an attaching member. The bill is comprised of a flexible elastomer and slides over a portion of the head. The bill comprises an aperture and is attachable on a protrusion of the head.

FIG. 8 shows a side view of a multi-piece artificial bird head of the present invention. The head is a receiving member and the bill is an attaching member. The bill is comprised of a flexible elastomer and slides over a portion of the head. The bill comprises an aperture and is attachable on a protrusion of the head. The bill is partially installed on the head.

FIG. 9 shows an attaching member of the present invention. The attaching member is a foot which attaches to a receiving member leg. The attaching member is comprised of a flexible elastomer and contains a re-configurable support.

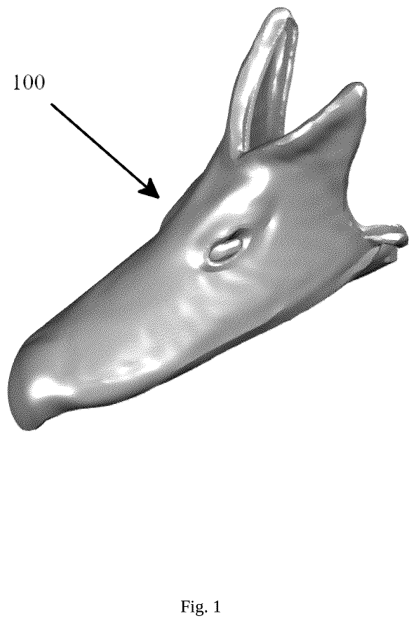

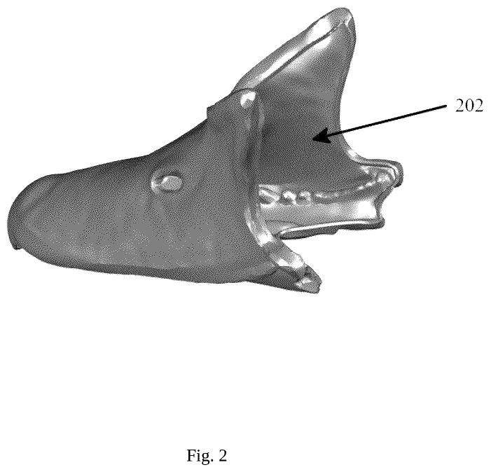

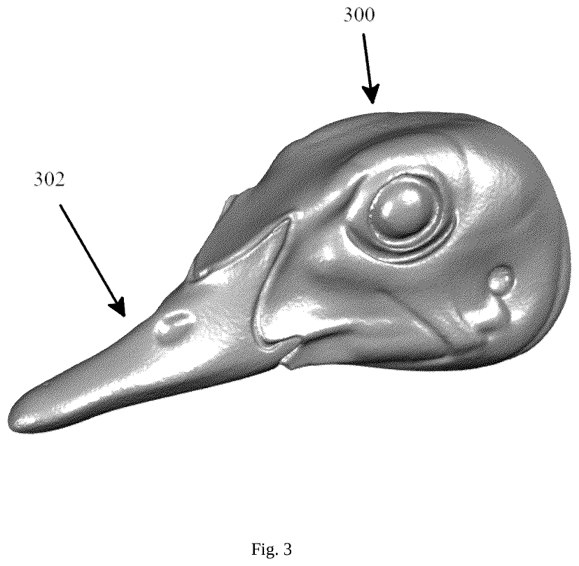

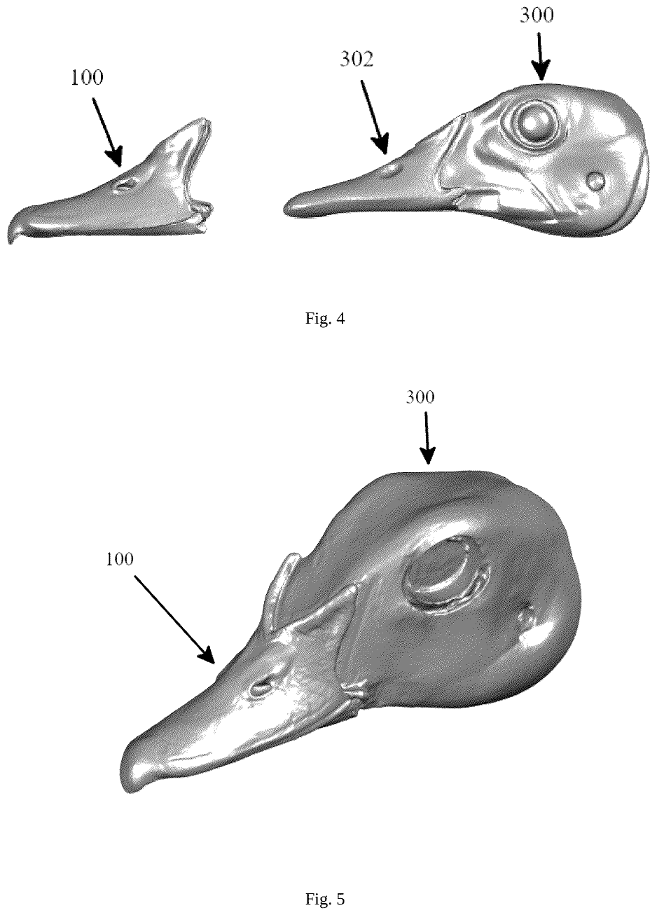

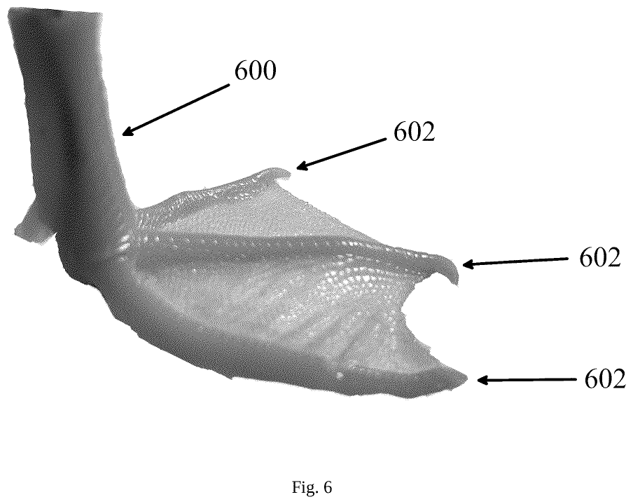

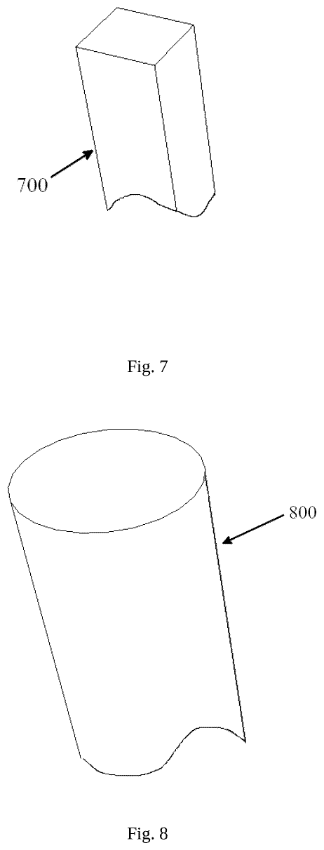

### DETAILED DESCRIPTION OF THE INVENTION

The apparatus of the present invention is a simulated animal part (appendage). The appendage may be a head, leg, neck, snout, or other part of an animal. The appendage comprises at least two pieces: a receiving member 300 and an attaching member 100. The attaching member 100 is removable from, and re-attachable to, the receiving member 300. A simulated animal may comprise a plurality of receiving and attaching members. Further, multiple attaching members may connect to a single receiving member. In a preferred embodiment, the receiving member is larger than the attaching member and located closer to the skeletal support of the animal. In one embodiment, the receiving member may be a head and attaching members may be a beak, eye, eye ring, bill, tongue, or waddle. In another embodiment, the receiving member may be a leg and attaching members may be a, foot, hoof, paw, pad, toe, or claw. The receiving and attaching members may be any part(s) of a simulated animal.

In a preferred embodiment, the attaching member 200 is flexible. In this embodiment, the attaching member 200 is preferably comprised of an elastomer and is sized and shaped with a cavity 202 such that it forms a friction fit when placed on a receiving region 302 of the receiving member 300. In a preferred embodiment, various sizes and colors of attaching members are interchangeable to permit a user to achieve a desired appearance. In certain variations of this embodiment, the attaching member 600 or receiving member is posable. A variety of posable means are well known in the art including wire frames 602, friction sockets, magnetic couplings, etc. The posable means permit the attaching and/or receiving member to be placed in, and remain in, configurable positions as desired.

In some embodiments, the receiving member is substantially rigid. In a preferred variation of this embodiment, the attaching member is substantially softer. In this preferred embodiment, the attaching member attaches to the receiving member using a protrusion and an aperture. The protrusion 700, 800 is preferably on the attaching member. The aperture and protrusion preferably conform to a standard such that various attaching members may be attached to a point according to a user's needs. In a preferred embodiment, the attaching member is affixed to the receiving member by friction. In an alternative embodiment, the attaching member is affixed to the receiving member using an adhesive. In a preferred embodiment, attaching members are pre-colored based on colors and/or color patterns common to a particular species of animal. In an alternative embodiment, the attaching member is configured to accept color by the end-user such that a user can color the attaching member according to a users desire/need. In a preferred embodiment, various sizes and configurations, such as open bills and closed bills, are attachable to an attachment point according to a user's needs.

For purposes of this application, including claims, plurality means one or more. Unless explicitly indicated otherwise, quantities are exemplary and other quantities are anticipated and may be practiced without deviating from this invention. For purposes of this application, including claims, appendage means a body part which projects directly or indirectly from another part of the body to which it is attached. For example, a beak or nose is an appendage which projects from a head, a fin is an appendage which projects from a body, etc. For purposes of this application, including claims, elastomer means a natural or synthetic polymer having elastic properties, e.g. rubber.

1. A simulated animal part comprising:
A) an attaching member resembling a natural external animal part configured to be attached to a receiving region of a receiving member.

2. The simulated animal part of claim 1 wherein:
A) the attaching member attaches to the receiving region of the receiving member with a
friction fit.

3. The simulated animal part of claim 2 wherein:
A) the receiving region of the receiving member resembles an under-sized version of the exterior of the attaching member.

4. The simulated animal part of claim 3 wherein:
A) the attaching member is comprised of an elastomer.

5. The simulated animal part of claim 3 wherein:
A) the attaching member is colored.

6. The simulated animal part of claim 3 wherein:
A) the attaching member is configured to accept color.

7. The simulated animal part of claim 3 wherein:
A) the attaching member comprises posable means.

8. A simulated animal part comprising:
A) a receiving member comprising a receiving region configured to be attached to an attaching member wherein the attaching member resembles a natural external animal part.

9. The simulated animal part of claim 8 wherein:
A) the attaching member attaches to the receiving region of the receiving member with a friction fit.

10. The simulated animal part of claim 9 wherein:
A) the receiving region of the receiving member resembles an under-sized version of the attaching member.

11. The simulated animal part of claim 8 wherein:
A) the attaching member comprises posable means.

12. A simulated animal part comprising:
A) a receiving member resembling a natural animal part,
B) an attaching member resembling a natural external animal part,
C) wherein said attaching member is configured to attach to said receiving member using
a friction fit between a protrusion and a cavity.

13. The simulated animal part of claim 12 wherein:
A) said attaching member comprises a cavity, and
B) said receiving member comprises a protrusion.

14. The simulated animal part of claim 13 wherein:
A) said protrusion of said receiving member resembles a reduced-size version of said
attaching member.

15. The simulated animal part of claim 13 wherein:
A) said attaching member is comprised of an elastomer.

16. The simulated animal part of claim 13 wherein:
A) said attaching member comprises a protrusion, and
B) said receiving member comprises an cavity.

17. The simulated animal part of claim 12 wherein:
A) said protrusion has a polygonal cross section.

18. The simulated animal part of claim 12 wherein:
A) said protrusion has an ellipse cross section.
